(19) United States
(12) Patent Application Publication
(10) Pub. No.: US 2006/0038324 A1
(43) Pub. Date: Feb. 23, 2006

(54) Molding method for curable poly(arylene ether) composition and article thereby

(76) Inventors: Gary William Yeager, Rexford, NY (US); Bryan Duffey, Ballston Spa, NY (US); Hua Guo, Selkirk, NY (US); Zhiqing Lin, Loudonville, NY (US); Nitin Vaish, Evansville, IN (US)

Correspondence Address: CANTOR COLBURN, LLP, 55 GRIFFIN ROAD SOUTH, BLOOMFIELD, CT, 06002, US

(21) Appl. No.: 10/923,518

(22) Filed: Aug. 20, 2004

(51) Int. Cl. B29C 43/02

(52) U.S. Cl. 264/319

(57) ABSTRACT

A curable composition containing a functionalized poly(arylene ether), an acryloyl monomer, and a filler is compression molded by a method that includes introducing the composition to a mold, closing the mold and applying a first temperature of about 120 to about 200° C. and a first pressure of about 1,000 to about 40,000 kilopascals for about 1 to about 100 seconds; opening the mold for about 0.005 to about 10 seconds; and closing the mold a second time and applying a second temperature of about 120 to about 200° C. and a second pressure of about 1,000 to about 40,000 kilopascals for about 20 to about 100 seconds. Molded articles formed by the method exhibit improved dielectric properties.

### BACKGROUND

Curable compositions comprising functionalized poly(arylene ether) resins have been described, for example, in U.S. Pat. Nos. 6,352,782 B2, 6,617,398 B2, and 6,627,704 B2 to Yeager et al. These compositions are useful for preparing a wide variety of useful articles, including fuel cell components, automotive parts, and circuit boards. However, some of the curable compositions described in these references have now been found to exhibit variable properties as a function of their molding conditions. In particular, when the curable compositions are used to fabricate dielectric materials for circuit boards, the dielectric properties have been observed to vary as a function of molding conditions. There is therefore a need for a molding method that provides better and more consistent dielectric properties.

### BRIEF SUMMARY

One embodiment is a method of compression molding a curable composition, comprising: introducing a curable poly(arylene ether) composition into a compression mold; closing the mold a first time and applying to the curable poly(arylene ether) composition a first temperature of about 120 to about 200° C. and a first pressure of about 1,000 to about 40,000 kilopascals for about 1 to about 100 seconds; opening the mold for about 0.005 to about 10 seconds; and closing the mold a second time and applying to the curable poly(arylene ether) composition a second temperature of about 120 to about 200° C. and a second pressure of about 1,000 to about 40,000 kilopascals for about 20 to about 100 seconds; wherein the curable poly(arylene ether) composition comprises a functionalized poly(arylene ether) resin, an olefinically unsaturated monomer, and a filler. In one embodiment, the total cycle time for the molding process may be about 80 to about 120 seconds.

Other embodiments, including articles prepared by the method, and curable compositions suitable for use in the method, are described in detail below.

### DETAILED DESCRIPTION OF THE PREFERRED EMBODIMENTS

While formulating curable compositions for use in the fabrication of dielectric materials for circuit boards, the present inventors observed that the dielectric properties of the cured articles were dependent not only on the curable composition, but also on the molding conditions used to produced the cured articles. In particular, when the curable composition was held constant, the impulse breakdown voltage was observed to depend on molding variables including the mold temperature and the breathe delay (e.g., in a molding cycle in which the mold closes, opens, closes again, and finally opens, the breathe delay is the time for which the mold is closed before the first opening). The present inventors conducted extensive research to develop a molding cycle that would provide optimum and robust properties in the cured articles.

The method comprises introducing a curable poly(arylene ether) composition into a compression mold; closing the mold a first time and applying to the curable poly(arylene ether) composition a first temperature of about 120 to about 200° C. and a first pressure of about 1,000 to about 40,000 kilopascals for about 1 to about 100 seconds; opening the mold for about 0.005 to about 10 seconds; and closing the mold a second time and applying to the curable poly(arylene ether) composition a second temperature of about 120 to about 200° C. and a second pressure of about 1,000 to about 40,000 kilopascals for about 20 to about 100 seconds to mold and cure the composition.

Within the range of about 120 to about 200° C., the first temperature and the second temperature independently may be specifically at least about 130° C., more specifically at least about 140° C. Also within this range, the first temperature and the second temperature independently may be specifically up to about 170° C., more specifically up to about 160° C.

Within the range of about 1,000 to about 40,000 kilopascals, the first pressure and the second pressure independently may be specifically at least about 2,000 kilopascals, more specifically at least about 4,000 kilopascals. Also within this range, the first pressure and the second pressure independently may be specifically up to about 20,000 kilopascals, more specifically up to about 10,000 kilopascals.

As noted above, the mold may be closed the first time for about 1 to about 100 seconds. Within this range, the time may specifically be at least about 5 seconds, more specifically at least about 10 seconds. Also within this range, the time may specifically be up to about 60 seconds, more specifically up to about 30 seconds.

Within the above range of opening the mold for about 0.005 to about 10 seconds, this time may be specifically at least about 0.01 second. Also within this range, the time may specifically be up to about 1 second, more specifically up to about 0.1 second.

Within the above range of applying a second temperature and a second pressure for about 20 to about 100 seconds, the time may be specifically at least about 30 seconds. Also within the range, the time may be specifically up to about 80 seconds, more specifically up to about 60 seconds.

The method includes closing the mold a first time and closing the mold a second time. These events may be characterized by a clamp speed, which is defined as the reciprocal of the time required to close the mold. In one embodiment, the clamp speed for the first and second closings may, independently, be about 0.05 to about 2 sec⁻¹. Within this range, the clamp speed may be specifically at least about 0.1 sec⁻¹. Also within this range, the clamp speed may be specifically up to about 1 sec⁻¹.

The curable poly(arylene ether) composition used in the method comprises a functionalized poly(arylene ether) resin, an olefinically unsaturated monomer, and a filler.

The functionalized poly(arylene ether) may be a capped poly(arylene ether) or a ring-functionalized poly(arylene ether). A capped poly(arylene ether) is defined herein as a poly(arylene ether) in which at least 50%, specifically at least 75%, more specifically at least 90%, yet more specifically at least 95%, even more specifically at least 99%, of the free hydroxyl groups present in the corresponding uncapped poly(arylene ether) have been functionalized by reaction with a capping agent.

The capped poly(arylene ether) may be represented by the structure
Q(J-K)_{y}
wherein Q is the residuum of a monohydric, dihydric, or polyhydric phenol, preferably the residuum of a monohydric or dihydric phenol; y is 1 to 100; J comprises repeating structural units having the formula 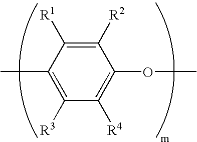
wherein m is 1 to about 200, preferably 2 to about 200, and R¹ and R³ are each independently hydrogen, halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, C₆-C₁₂ aryl (including phenyl), C₁-C₁₂ haloalkyl, C₁-C₁₂ hydrocarbonoxy, C₂-C₁₂ halohydrocarbonoxy wherein at least two carbon atoms separate the halogen and oxygen atoms, or the like; R² and R⁴ are each independently halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, C₆-C₁₂ aryl (including phenyl), C₁-C₁₂ haloalkyl, C₁-C₁₂ hydrocarbonoxy, C₂-C₁₂ halohydrocarbonoxy wherein at least two carbon atoms separate the halogen and oxygen atoms, or the like; and K is a capping group produced by reaction of a phenolic hydroxyl group on the poly(arylene ether) with a capping reagent. The resulting capping group may have the structure 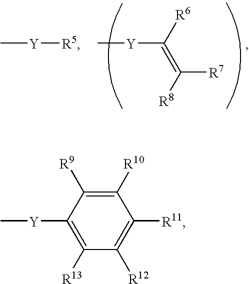
or the like, wherein R⁵ is C₁-C₁₂ alkyl, or the like; R⁶-R⁸ are each independently hydrogen, C₁-C₁₈ hydrocarbyl, C₂-C₁₈ hydrocarbyloxycarbonyl, nitrile, formyl, carboxylate, imidate, thiocarboxylate, or the like; R⁹-R¹³ are each independently hydrogen, halogen, C₁-C₁₂ alkyl, hydroxy, amino, or the like; and wherein Y is a divalent group such as 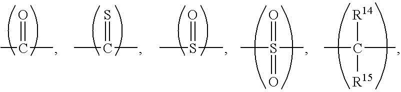
or the like, wherein R¹⁴ and R¹⁵ are each independently hydrogen, C₁-C₁₂ alkyl, or the like. As used herein, “hydrocarbyl” refers to a residue that contains only carbon and hydrogen. The residue may be aliphatic or aromatic, straight-chain, cyclic, branched, saturated or unsaturated. The hydrocarbyl residue, when so stated however, may contain heteroatoms over and above the carbon and hydrogen members of the substituent residue. Thus, when specifically noted as containing such heteroatoms, the hydrocarbyl residue may also contain carbonyl groups (—C(O)—), ether groups (—O—), amino groups (—NH₂), hydroxyl groups (—OH), thiol groups (—SH), thioether groups (—S—), or the like, or it may contain heteroatoms within the backbone of the hydrocarbyl residue. As used herein, the term “haloalkyl” includes alkyl groups substituted with one or more halogen atoms, including partially and fully halogenated alkyl groups.

In one embodiment, Q is the residuum of a phenol, including polyfunctional phenols, and includes radicals of the structure 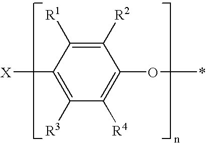
wherein R¹ and R³ are each independently hydrogen, halogen, primary or secondary C₁-C₁₂ alkyl, C₁-C₁₂ alkenyl, C₁-C₁₂ alkynyl, C₁-C₁₂ aminoalkyl, C₁-C₁₂ hydroxyalkyl, C₆-C₁₂ aryl (including phenyl), C₁-C₁₂ haloalkyl, C₁-C₁₂ aminoalkyl, C₁-C₁₂ hydrocarbonoxy, C₁-C₁₂ halohydrocarbonoxy wherein at least two carbon atoms separate the halogen and oxygen atoms, or the like; R² and R⁴ are each independently halogen, primary or secondary C₁-C₁₂ alkyl, C₁-C₁₂ alkenyl, C₁-C₁₂ alkynyl, C₁-C₁₂ aminoalkyl, C₁-C₁₂ hydroxyalkyl, C₆-C₁₂ aryl (including phenyl), C₁-C₁₂ haloalkyl, C₁-C₁₂ aminoalkyl, C₁-C₁₂ hydrocarbonoxy, C₁-C₁₂ halohydrocarbonoxy wherein at least two carbon atoms separate the halogen and oxygen atoms, or the like; X may be hydrogen, C₁-C₁₈ hydrocarbyl, or C₁-C₁₈ hydrocarbyl containing a substituent such as carboxylic acid, aldehyde, alcohol, amino radicals, or the like; X also may be sulfur, sulfonyl, sulfuryl, oxygen, C₁-C₁₂ alkylidene, or other such bridging group having a valence of 2 or greater to result in various bis- or higher polyphenols; y and n are each independently 1 to about 100, preferably 1 to 3, and more preferably about 1 to 2; in a preferred embodiment, y=n. Q may be the residuum of a monohydric phenol. Q may also be the residuum of a diphenol, such as 2,2′,6,6′-tetramethyl-4,4′-diphenol. Q may also be the residuum of a bisphenol, such as 2,2-bis(4-hydroxyphenyl)propane (“bisphenol A” or “BPA”).

In one embodiment, the capped poly(arylene ether) is produced by capping a poly(arylene ether) consisting essentially of the polymerization product of at least one monohydric phenol having the structure 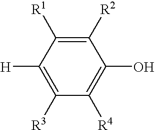
wherein R¹ and R³ are each independently hydrogen, halogen, primary or secondary C₁-C₁₂ alkyl, C₁-C₁₂ alkenyl, C₁-C₁₂ alkynyl, C₁-C₁₂ aminoalkyl, C₁-C₁₂ hydroxyalkyl, C₆-C₁₂ aryl (including phenyl), C₁-C₁₂ haloalkyl, C₁-C₁₂ aminoalkyl, C₁-C₁₂ hydrocarbonoxy, C₁-C₁₂ halohydrocarbonoxy wherein at least two carbon atoms separate the halogen and oxygen atoms, or the like; and R² and R⁴ are each independently halogen, primary or secondary C₁-C₁₂ alkyl, C₁-C₁₂ alkenyl, C₁-C₁₂ alkynyl, C₁-C₁₂ aminoalkyl, C₁-C₁₂ hydroxyalkyl, C₆-C₁₂ aryl (including phenyl), C₁-C₁₂ haloalkyl, C₁-C₁₂ aminoalkyl, C₁-C₁₂ hydrocarbonoxy, C₁-C₁₂ halohydrocarbonoxy wherein at least two carbon atoms separate the halogen and oxygen atoms, or the like. Suitable monohydric phenols include those described in U.S. Pat. No. 3,306,875 to Hay, and highly preferred monohydric phenols include 2,6-dimethylphenol and 2,3,6-trimethylphenol. The poly(arylene ether) may be a copolymer of at least two monohydric phenols, such as 2,6-dimethylphenol and 2,3,6-trimethylphenol.

In one embodiment, the capped poly(arylene ether) comprises at least one capping group having the structure 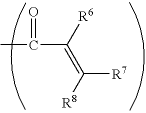
wherein R⁶-R⁸ are each independently hydrogen, C₁-C₁₈ hydrocarbyl, C₂-C₁₈ hydrocarbyloxycarbonyl, nitrile, formyl, carboxylate, imidate, thiocarboxylate, or the like; R⁹-R¹³ are each independently hydrogen, halogen, C₁-C₁₂ alkyl, hydroxy, amino, or the like. Highly preferred capping groups include acrylate (R⁶=R⁷=R⁸=hydrogen) and methacrylate (R⁶=methyl, R⁷=R⁸=hydrogen). It will be understood that the prefix “(meth)acryl-” means either “acryl-” or “methacryl-”.

In another embodiment, the capped poly(arylene ether) comprises at least one capping group having the structure 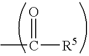
wherein R⁵ is C₁-C₁₂ alkyl, preferably C₁-C₆ alkyl, more preferably methyl, ethyl, or isopropyl. The advantageous properties of their invention can be achieved even when the capped poly(arylene ether) lacks a polymerizable function such as a carbon-carbon double bond.

In yet another embodiment, the capped poly(arylene ether) comprises at least one capping group having the structure 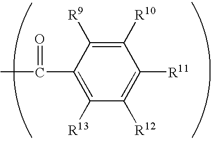
wherein R⁹-R¹³ are each independently hydrogen, halogen, C₁-C₁₂ alkyl, hydroxy, amino, or the like. Preferred capping groups of this type include salicylate (R⁹=hydroxy, R¹⁰-R¹³=hydrogen).

In still another embodiment, the capped poly(arylene ether) comprises at least one capping group having the structure 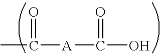
wherein A is a saturated or unsaturated C₂-C₁₂ divalent hydrocarbon group such as, for example, ethylene, 1,2-propylene, 1,3-propylene, 2-methyl-1,3-propylene, 2,2-dimethyl-1,3-propylene, 1,2-butylene, 1,3-butylene, 1,4-butylene, 2-methyl-1,4-butylene, 2,2-dimethyl-1,4-butylene, 2,3-dimethyl-1,4-butylene, vinylene (—CH═CH—), 1,2-phenylene, and the like. These capped poly(arylene ether) resins may conveniently be prepared, for example, by reaction of an uncapped poly(arylene ether) with a cyclic anhydride capping agent. Such cyclic anhydride capping agents include, for example, maleic anhydride, succinic anhydride, glutaric anhydride, adipic anhydride, phthalic anhydride, and the like.

There is no particular limitation on the method by which the capped poly(arylene ether) is prepared. The capped poly(arylene ether) may be formed by the reaction of an uncapped poly(arylene ether) with a capping agent. Capping agents include compounds known in the literature to react with phenolic groups. Such compounds include both monomers and polymers containing, for example, anhydride, acid chloride, epoxy, carbonate, ester, isocyanate, cyanate ester, or alkyl halide radicals. Capping agents are not limited to organic compounds as, for example, phosphorus and sulfur based capping agents also are included. Examples of capping agents include, for example, acetic anhydride, succinic anhydride, maleic anhydride, salicylic anhydride, polyesters comprising salicylate units, homopolyesters of salicylic acid, acrylic anhydride, methacrylic anhydride, glycidyl acrylate, glycidyl methacrylate, acetyl chloride, benzoyl chloride, diphenyl carbonates such as di(4-nitrophenyl)carbonate, acryloyl esters, methacryloyl esters, acetyl esters, phenylisocyanate, 3-isopropenyl-α,α-dimethylphenylisocyanate, cyanatobenzene, 2,2-bis(4-cyanatophenyl)propane), 3-(alpha-chloromethyl)styrene, 4-(alpha-chloromethyl)styrene, allyl bromide, and the like, carbonate and substituted derivatives thereof, and mixtures thereof. These and other methods of forming capped poly(arylene ether)s are described, for example, in U.S. Pat. No. 3,375,228 to Holoch et al.; U.S. Pat. No. 4,148,843 to Goossens; U.S. Pat. Nos. 4,562,243, 4,663,402, 4,665,137, and 5,091,480 to Percec et al.; U.S. Pat. Nos. 5,071,922, 5,079,268, 5,304,600, and 5,310,820 to Nelissen et al.; U.S. Pat. No. 5,338,796 to Vianello et al.; U.S. Pat. No. 6,627,704 B2 to Yeager et al.; and European Patent No. 261,574 B1 to Peters et al.

In one embodiment, the capped poly(arylene ether) may be prepared by reaction of an uncapped poly(arylene ether) with an anhydride in an olefinically unsaturated monomer as solvent. This approach has the advantage of generating the capped poly(arylene ether) in a form that can be immediately blended with other components to form a curable composition; using this method, no isolation of the capped poly(arylene ether) or removal of unwanted solvents or reagents is required.

A capping catalyst may be employed in the reaction of an uncapped poly(arylene ether) with an anhydride. Examples of such compounds include those known to the art that are capable of catalyzing condensation of phenols with the capping agents described above. Useful materials are basic compounds including, for example, basic compound hydroxide salts such as sodium hydroxide, potassium hydroxide, tetraalkylammonium hydroxides, and the like; tertiary alkylamines such as tributyl amine, triethylamine, dimethylbenzylamine, dimethylbutylamine and the like; tertiary mixed alkyl-arylamines and substituted derivatives thereof such as N,N-dimethylaniline; heterocyclic amines such as imidazoles, pyridines, and substituted derivatives thereof such as 2-methylimidazole, 2-vinylimidazole, 4-(dimethylamino)pyridine, 4-(1-pyrrolino)pyridine, 4-(1-piperidino)pyridine, 2-vinylpyridine, 3-vinylpyridine, 4-vinylpyridine, and the like. Also useful are organometallic salts such as, for example, tin and zinc salts known to catalyze the condensation of, for example, isocyanates or cyanate esters with phenols.

The functionalized poly(arylene ether) may be a ring-functionalized poly(arylene ether). In one embodiment, the ring-functionalized poly(arylene ether) is a poly(arylene ether) comprising repeating structural units of the formula 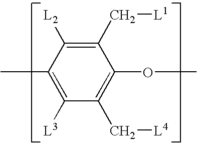
wherein each L¹-L⁴ is independently hydrogen, an alkenyl group, or an alkynyl group; wherein the alkenyl group is represented by 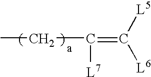
wherein L⁵-L⁷ are independently hydrogen or methyl, and a is an integer from 0 to 4; wherein the alkynyl group is represented by 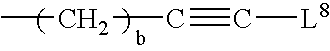
wherein L⁸ is hydrogen, methyl, or ethyl, and b is an integer from 0 to 4; and wherein about 0.02 mole percent to about 25 mole percent of the total L¹-L⁴ substituents in the ring-functionalized poly(arylene ether) are alkenyl and/or alkynyl groups. Within this range, alkenyl and/or alkynyl group content may specifically be at least about 0.1 mole percent, more specifically at least about 0.5 mole percent, alkenyl and/or alkynyl groups. Also within this range, the alkenyl and/or alkynyl groups may preferably be up to about 15 mole percent, more specifically up to about 10 mole percent. The ring-functionalized poly(arylene ether) of this embodiment may be prepared according to known methods. For example, an unfunctionalized poly(arylene ether) such as poly(2,6-dimethyl-1,4-phenylene ether) may be metallized with a reagent such as n-butyl lithium and subsequently reacted with an alkenyl halide such as allyl bromide and/or an alkynyl halide such as propargyl bromide. This and other methods for preparation of ring-functionalized poly(arylene ether) resins are described, for example, in U.S. Pat. No. 4,923,932 to Katayose et al.

In another embodiment, the ring-functionalized poly(arylene ether) is the product of the melt reaction of a poly(arylene ether) and an α,β-unsaturated carbonyl compound or a β-hydroxy carbonyl compound. Examples of α,β-unsaturated carbonyl compounds include, for example, maleic anhydride, citriconic anhydride, and the like. Examples of β-hydroxy carbonyl compounds include, for example, citric acid, and the like. Such functionalization is typically carried out by melt mixing the poly(arylene ether) with the desired carbonyl compound at a temperature of about 190 to about 290° C.

There is no particular limitation on the molecular weight or intrinsic viscosity of the functionalized poly(arylene ether). In one embodiment, the composition may comprise a functionalized poly(arylene ether) having a number average molecular weight of about 3,000 to about 25,000 atomic mass units (AMU). Within this range, the number average molecular weight specifically may be at least about 10,000 AMU, more specifically at least about 15,000 AMU. In another embodiment, the composition may comprise a functionalized poly(arylene ether) having an intrinsic viscosity of about 0.05 to about 0.6 deciliters per gram (dL/g) as measured in chloroform at 25° C. Within this range, the functionalized poly(arylene ether) intrinsic viscosity may specifically be at least about 0.1 dL/g. Also within this range, the functionalized poly(arylene ether) intrinsic viscosity may specifically be up to about 0.5 dL/g, still more specifically up to about 0.4 dL/g. Generally, the intrinsic viscosity of a functionalized poly(arylene ether) will vary insignificantly from the intrinsic viscosity of the corresponding unfunctionalized poly(arylene ether). Specifically, the intrinsic viscosity of a functionalized poly(arylene ether) will generally be within 10% of that of the unfunctionalized poly(arylene ether). It is expressly contemplated to employ blends of at least two functionalized poly(arylene ether)s having different molecular weights and intrinsic viscosities. The composition may comprise a blend of at least two functionalized poly(arylene ethers). Such blends may be prepared from individually prepared and isolated functionalized poly(arylene ethers). Alternatively, such blends may be prepared by reacting a single poly(arylene ether) with at least two functionalizing agents. For example, a poly(arylene ether) may be reacted with two capping agents, or a poly(arylene ether) may be metallized and reacted with two unsaturated alkylating agents. In another alternative, a mixture of at least two poly(arylene ether) resins having different monomer compositions and/or molecular weights may be reacted with a single functionalizing agent.

The curable composition may comprise the functionalized poly(arylene ether) in an amount of comprising about 1 to about 90 parts by weight per 100 parts by weight total of the functionalized poly(arylene ether) and the olefinically unsaturated monomer. Within this range, the functionalized poly(arylene ether) amount specifically may be at least about 10 parts by weight, more specifically at least about 20 parts by weight, still more specifically at least about 30 parts by weight. Also within this range, the functionalized poly(arylene ether) amount specifically may be up to about 80 parts by weight, more specifically up to about 70 parts by weight, yet more specifically up to about 60 parts by weight, still more specifically up to about 50 parts by weight.

The curable composition comprises an olefinically unsaturated monomer. The olefinically unsaturated monomer may be selected from acryloyl monomers, alkenyl aromatic monomers, allylic monomers, vinyl ethers, maleimides, and the like, and mixtures thereof.

The olefinically unsaturated monomer may comprise an acryloyl monomer. In one embodiment, the acryloyl monomer comprises at least one acryloyl moiety having the structure 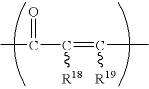
wherein R¹⁸ and R¹⁹ are each independently selected from the group consisting of hydrogen and C₁-C₁₂ alkyl, and wherein R¹⁸ and R¹⁹ may be disposed either cis or trans about the carbon-carbon double bond.

In another embodiment, the acryloyl monomer comprises at least one acryloyl moiety having the structure 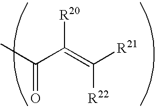
wherein R²⁰-R²² are each independently selected from the group consisting of hydrogen, C₁-C₁₂ hydrocarbyl, C₂-C₁₈ hydrocarbyloxycarbonyl, nitrile, formyl, carboxylate, imidate, and thiocarboxylate.

In a preferred embodiment, the acryloyl monomer may include compounds having at least two acryloyl moieties per molecule, more specifically at least three acryloyl moieties per molecule. Illustrative examples include compounds produced by condensation of an acrylic or methacrylic acid with a di-epoxide, such as bisphenol-A diglycidyl ether, butanediol diglycidyl ether, or neopenylene glycol dimethacrylate. Specific examples include 1,4-butanediol diglycidylether di(meth)acrylate, bisphenol A diglycidylether dimethacrylate, and neopentylglycol diglycidylether di(meth)acrylate, and the like. Also included as acryloyl monomers are the condensation of reactive acrylate or methacrylate compounds with alcohols or amines to produce the resulting polyfunctional acrylates or polyfunctional acrylamides. Examples include N,N-bis(2-hydroxyethyl)(meth)acrylamide, methylenebis((meth)acrylamide), 1,6-hexamethylenebis((meth)acrylamide), diethylenetriamine tris((meth)acrylamide), bis(γ-((meth)acrylamide)propoxy) ethane, β-((meth)acrylamide) ethylacrylate, ethylene glycol di((meth)acrylate)), diethylene glycol di(meth)acrylate, tetraethylene glycol di(meth)acrylate, glycerol di(meth)acrylate, glycerol tri(meth)acrylate, 1,3-propylene glycol di(meth)acrylate, dipropyleneglycol di(meth)acrylate, 1,4-butanediol di(meth)acrylate, 1,2,4-butanetriol tri(meth)acrylate, 1,6-hexanedioldi(meth)acrylate, 1,4-cyclohexanediol di(meth)acrylate, 1,4-benzenediol di(meth)acrylate, pentaerythritol tetra(meth)acrylate, 1,5-pentanediol di(meth)acrylate, trimethylolpropane di(meth)acrylate, trimethylolpropane tri(meth)acrylate), 1,3,5-triacryloylhexahydro-1,3,5-triazine, 2,2-bis(4-(2-(meth)acryloxyethoxy)phenyl)propane, 2,2-bis(4-(2-(meth)acryloxyethoxy)-3,5-dibromophenyl)propane, 2,2-bis((4-(meth)acryloxy)phenyl)propane, 2,2-bis((4-(meth)acryloxy)-3,5-dibromophenyl)propane, and the like, and mixtures thereof.

In one embodiment, the acryloyl monomer is selected from trimethylolpropane tri(meth)acrylate, 1,6-hexanediol di(meth)acrylate, neopentyl glycol di(meth)acrylate, dipropylene glycol di(meth)acrylate, ethylene glycol di(meth)acrylate, propylene glycol di(meth)acrylate, cyclohexanedimethanol di(meth)acrylate, butanediol di(meth)acrylate, diethylene glycol di(meth)acrylate, triethylene glycol di(meth)acrylate, isobornyl (meth)acrylate, methyl (meth)acrylate, methacryloxypropyl trimethoxysilane, ethoxylated (2) bisphenol A di(meth)acrylate, and the like, and mixtures thereof.

Suitable further include acryloyl monomers further include the alkoxylated acryloyl monomers described in U.S. Patent Application Publication No. U.S. 2003-0096123 A1 to Yeager et al. Briefly, the alkoxylated acryloyl monomer may have the structure 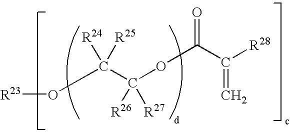
wherein R²³ is a C₁-C₂₅₀ organic group having a valence of c; each occurrence of R²⁴-R²⁷ is independently hydrogen, C₁-C₆ alkyl, or C₆-C₁₂ aryl; each occurrence of d is independently 0 to about 20 with the proviso that at least one occurrence of d is at least 1; each occurrence of R²⁸ is independently hydrogen or methyl; and c is 1 to about 10. In one embodiment, the alkoxylated acryloyl monomer comprises at least two (meth)acrylate groups. In another embodiment, the alkoxylated acryloyl monomer comprises at least three (meth)acrylate groups. Suitable alkoxylated acryloyl monomers include, for example, (ethoxylated)₁₋₂₀ nonylphenol (meth)acrylate, (propoxylated)₁₋₂₀ nonylphenol (meth)acrylate, (ethoxylated)₁₋₂₀ tetrahydrofurfuryl (meth)acrylate, (propoxylated)₁₋₂₀ tetrahydrofurfuryl (meth)acrylate, (ethoxylated)₁₋₂₀ hydroxyethyl (meth)acrylate, (propoxylated)₁₋₂₀ hydroxyethyl (meth)acrylate, (ethoxylated)₂₋₄₀ 1,6-hexanediol di(meth)acrylate, (propoxylated)₂₋₄₀ 1,6-hexanediol di(meth)acryl ate, (ethoxylated)₂₋₄₀ 1,4-butanediol di(meth)acrylate, (propoxylated)₂₋₄₀ 1,4-butanediol di(meth)acrylate, (ethoxylated)₂₋₄₀ 1,3-butanediol di(meth)acrylate, (propoxylated)₂₋₄₀ 1,3-butanediol di(meth)acrylate, (ethoxylated)₂₋₄₀ ethylene glycol di(meth)acrylate, (propoxylated)₂₋₄₀ ethylene glycol di(meth)acrylate, (ethoxylated)₂₋₄₀ propylene glycol di(meth)acrylate, (propoxylated)₂₋₄₀ propylene glycol di(meth)acrylate, (ethoxylated)₂₋₄₀ 1,4-cyclohexanedimethanol di(meth)acrylate, (propoxylated)₂₋₄₀ 1,4-cyclohexanedimethanol di(meth)acrylate, (ethoxylated)₂₋₄₀ bisphenol-A di(meth)acrylate, (propoxylated)₂₋₄₀ bisphenol-A di(meth)acrylate, (ethoxylated)₃₋₆₀ glycerol tri(meth)acrylate, (propoxylated)₃₋₆₀ glycerol tri(meth)acrylate, (ethoxylated)₃₋₆₀ trimethylolpropane tri(meth)acrylate, (propoxylated)₃₋₆₀ trimethylolpropane tri(meth)acrylate, (ethoxylated)₃₋₆₀ isocyanurate tri(meth)acrylate, (propoxylated)₃₋₆₀ isocyanurate tri(meth)acrylate, (ethoxylated)₄₋₈₀ pentaerythritol tetra(meth)acrylate, (propoxylated)₄₋₈₀ pentaerythritol tetra(meth)acrylate, (ethoxylated)₆₋₁₂₀ dipentaerythritol tetra(meth)acrylate, (propoxylated)₆₋₁₂₀ dipentaerythritol tetra(meth)acrylate, and the like, and mixtures thereof.

Many additional suitable acryloyl monomers are described in U.S. Pat. No. 6,627,704 B2 to Yeager et al.

The olefinically unsaturated monomer may comprise an alkenyl aromatic monomer. The alkenyl aromatic monomer may have the formula 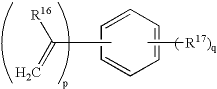
wherein each occurrence of R¹⁶ is independently hydrogen or C₁-C₁₈ hydrocarbyl; each occurrence of R¹⁷ is independently halogen, C₁-C₁₂ alkyl, C₁-C₁₂ alkoxyl, or C₆-C₁₈ aryl; p is 1 to 4; and q is 0 to 5. Suitable alkenyl aromatic monomers include, for example, styrene, α-methylstyrene, 2-methylstyrene, 3-methylstyrene, 4-methylstyrene, 2-t-butylstyrene, 3-t-butylstyrene, 4-t-butylstyrene, 1,3-divinylbenzene, 1,4-divinylbenzene, 1,3-diisopropenylbenzene, 1,4-diisopropenylbenzene, styrenes having from 1 to 5 halogen substituents on the aromatic ring, and the like, and combinations thereof. Preferred alkenyl aromatic monomers include styrene and divinyl benzenes.

The olefinically unsaturated monomer may comprise an allylic monomer. An allylic monomer is an organic compound comprising at least one, preferably at least two, more preferably at least three allyl (—CH₂—CH═CH₂) groups. Suitable allylic monomers include, for example, diallyl phthalate, diallyl isophthalate, triallyl mellitate, triallyl mesate, triallyl benzenes, triallyl cyanurate, triallyl isocyanurate, mixtures thereof, partial polymerization products prepared therefrom, and the like.

The olefinically unsaturated monomer may comprise a vinyl ether. Vinyl ethers are compounds comprising at least one moiety having the structure
H₂C═CH—O—*.
Suitable vinyl ethers include, for example, 1,2-ethylene glycol divinyl ether, 1,3-propanediol divinyl ether, 1,4-butanediol divinyl ether, triethyleneglycol divinyl ether, 1,4-cyclohexanedimethanol divinyl ether, ethyl vinyl ether, n-butyl vinyl ether, lauryl vinyl ether, 2-chloroethyl vinyl ether, and the like, and mixtures thereof.

The olefinically unsaturated monomer may comprise a maleimide. A maleimide is a compound comprising at least one moiety having the structure 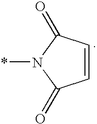
Suitable maleimides include, for example, N-phenylmaleimide, 1,4-phenylene-bis-methylene-α,α′-bismaleimide, 2,2-bis(4-phenoxyphenyl)-N,N′-bismaleimide, N,N′-phenylene bismaleimide, N,N′-hexamethylene bismaleimide, N-N′-diphenyl methane bismaleimide, N,N′-oxy-di-p-phenylene bismaleimide, N,N′-4,4′-benzophenone bismaleimide, N,N′-p-diphenylsulfone bismaleimide, N,N′-(3,3′-dimethyl)methylene-di-p-phenylene bismaleimide, poly(phenylmethylene) polymaleimide, bis(4-phenoxyphenyl) sulfone-N,N′-bismaleimide, 1,4-bis(4-phenoxy)benzene-N,N′-bismaleimide, 1,3-bis(4-phenoxy)benzene-N,N′-bismaleimide, 1,3-bis(3-phenoxy)benzene-N,N′-bismaleimide, and the like, and mixtures thereof.

The curable composition may comprise the olefinically unsaturated monomer in an amount of about 10 to about 99 parts by weight per 100 parts by weight total of the functionalized poly(arylene ether) and the olefinically unsaturated monomer. Within this range, the olefinically unsaturated monomer amount may specifically be at least about 20 parts by weight, more specifically at least about 30 parts by weight, still more specifically at least about 40 parts by weight. Also within this range the olefinically unsaturated monomer amount may specifically be up to about 90 parts by weight, more specifically up to about 80 parts by weight, yet more specifically up to about 70 parts by weight, even more specifically up to about 60 parts by weight.

The curable composition comprises a filler. Suitable fillers include particulate fillers, fibrous fillers, and mixtures thereof. A particulate filler is herein defined as a filler having an average aspect ratio less than about 5:1. Non-limiting examples of fillers include silica powder, such as fused silica and crystalline silica; boron-nitride powder and boron-silicate powders for obtaining cured products having high thermal conductivity, low dielectric constant and low dielectric loss tangent; the above-mentioned powder as well as alumina, and magnesium oxide (or magnesia) for high temperature conductivity; and fillers, such as wollastonite including surface-treated wollastonite, calcium sulfate (in its anhydrous, hemihydrated, dihydrated, or trihydrated forms), calcium carbonate including chalk, limestone, marble and synthetic, precipitated calcium carbonates, generally in the form of a ground particulate which often comprises 98+% CaCO₃ with the remainder being other inorganics such as magnesium carbonate, iron oxide, and alumino-silicates; surface-treated calcium carbonates; talc, including fibrous, nodular, needle shaped, and lamellar talc; glass spheres, both hollow and solid, and surface-treated glass spheres typically having coupling agents such as silane coupling agents and/or containing a conductive coating; and kaolin, including hard, soft, calcined kaolin, and kaolin comprising various coatings known to the art to facilitate the dispersion in and compatibility with the thermoset resin; mica, including metallized mica and mica surface treated with aminosilane or acryloylsilane coatings to impart good physical properties to compounded blends; feldspar and nepheline syenite; silicate spheres; flue dust; cenospheres; fillite; aluminosilicate (armospheres), including silanized and metallized aluminosilicate; natural silica sand; quartz; quartzite; perlite; Tripoli; diatomaceous earth; synthetic silica, including those with various silane coatings; and the like.

Fibrous fillers include short inorganic fibers, including processed mineral fibers such as those derived from blends comprising at least one of aluminum silicates, aluminum oxides, magnesium oxides, and calcium sulfate hemihydrate. Also included among fibrous fillers are single crystal fibers or “whiskers” including silicon carbide, alumina, boron carbide, carbon, iron, nickel, copper. Also included among fibrous fillers are glass fibers, including textile glass fibers such as E, A, C, ECR, R, S, D, and NE glasses and quartz. Preferred fibrous fillers include glass fibers having a diameter in about 5 to about 25 micrometers and a length before compounding in a range of about 0.5 to about 4 centimeters. Many other suitable fillers are described in U.S. Pat. Nos. 6,352,782 B2 and 6,627,704 B2 to Yeager et al.

The formulation may also contain adhesion promoters to improve adhesion of the thermosetting resin to the filler or to an external coating or substrate. Adhesion promoters include chromium complexes, silanes, titanates, zirco-aluminates, propylene maleic anhydride copolymers, reactive cellulose esters and the like. Chromium complexes include those sold by DuPont under the tradename VOLAN®. Silanes include molecules having the general structure (RO)₍₄₋ₙ₎SiYₙ wherein n=1-3, R is an alkyl or aryl group and Y is a reactive functional group which can enable formation of a bond with a polymer molecule. Particularly useful examples of coupling agents are those having the structure (RO)₃SiY. Typical examples include vinyl triethoxysilane, vinyl tris(2-methoxy)silane, phenyl trimethoxysilane, Γ-methacryloxypropyltrimethoxy silane, γ-aminopropyltriethoxysilane, γ-glycidoxypropyltrimethoxysilane, γ-mercaptopropyltrimethoxysilane, and the like. Silanes further include molecules lacking a reactive functional group, such as, for example, trimethoxyphenylsilane. The adhesion promoter may be included in the thermosetting resin itself, or coated onto any of the fillers described above to improve adhesion between the filler and the thermosetting resin. For example such promoters may be used to coat a silicate fiber or filler to improve adhesion of the resin matrix.

The filler may be used in an amount of about 5 to about 95 weight percent, based on the total weight of the composition. Within this range, the filler amount may specifically be at least about 20 weight percent, more specifically at least about 40 weight percent, even more specifically at least about 75 weight percent. Also within this range, the filler amount may specifically be up to about 93 weight percent, more specifically up to about 91 weight percent.

The curable composition may, optionally, further comprise a polyolefin powder having an average particle size less than 100 micrometers. The particle size may specifically be less than 50 micrometers, more specifically less than 30 micrometers. When added to the curable composition, the polyolefin powder may increase stiffness and toughness, and reduce shrinkage. Suitable polyolefin powders include so-called micronized powders comprising high density polyethylene, low density polyethylene, polypropylene, poly(ethylene-co-vinyl acetate), halogenated polyolefins such as polytetrafluoroethylene, and mixtures thereof.

When present, the polyolefin powder may be used in an amount of about 1 to about 50 parts by weight of the polyolefin per 100 parts by weight total of the functionalized poly(arylene ether) and the olefinically unsaturated monomer. Within this range, the polyolefin powder amount may specifically be at least about 5 parts by weight, more specifically at least about 10 parts by weight. Also within this range, the polyolefin powder amount may specifically be up to about 30 parts by weight, more specifically up to about 20 parts by weight.

In addition to the polyolefin powder, the curable composition may further comprise a polymeric additive selected from polybutadienes, polybutadiene-polystyrene block copolymers (e.g., the polystyrene-polybutadiene-polystyrene triblock copolymer sold as KRATON® D1101 by Kraton Polymers), polystyrene-polyisoprene block copolymers (e.g., the polystyrene-polyisoprene-polystyrene triblock copolymer sold as KRATON® D1107 by Kraton Polymers), hydrogenated polystyrene-polybutadiene block copolymers (e.g., the hydrogenated polystyrene-polybutadiene-polystyrene triblock copolymer sold as KRATON® G1652 by Kraton Polymers), hydrogenated polystyrene-polyisoprene block copolymers (e.g. the polystyrene-polyisoprene diblock copolymer sold as KRATON® G1702 by Kraton Polymers), maleinized polybutadiene (e.g., the maleinized polybutadienes sold as 131MA5, R131MA10, and R130MA8 by Ricon), maleinized styrene-butadiene random copolymers, maleinized polystyrene-polybutadiene block copolymers (e.g., Kraton FG type, from Kraton Polymers), polyvinylacetate, polybutadiene-polyisoprene block copolymers, hydrogenated polybutadiene-polyisoprene block copolymers, and the like, and mixtures thereof.

In one embodiment, the curable composition further comprises a hydroxy-containing polymer. The hydroxy-containing polymer functions, at least, as a viscosity modifier. Suitable hydroxy-containing polymers include, for example, polyalkylene glycols, hydroxy-containing hydrocarbon polymers, hydroxy-containing polyesters, hydroxy-containing polycarbonates, and the like, and mixtures thereof. The hydroxy-containing compound may have 1 to about 6 hydroxy groups per molecule, specifically 2 or 3 hydroxy groups per molecule, more specifically 2 hydroxy groups per molecule. The hydroxy-containing polymer may have a number average molecular weight of about 200 to about 10,000 AMU. Within this range, the number average molecular weight may specifically be at least about 300 AMU, more specifically at least about 400 AMU. Also within this range, the number average molecular weight may specifically be up to about 8,000 AMU, more specifically up to about 6,000 AMU.

The hydroxy-containing polymer may comprise a polyalkylene glycol. The polyalkylene glycol may generally have the structure
HO [symbol] R²⁹—O [symbol] ₛH
wherein R²⁹ is C₂-C₆ alkylene and s is about 5 to about 200. The value of s may specifically be at least about 10, more specifically at least about 20, still more specifically at least about 40. The value of s may also be specifically up to about 150, more specifically up to about 100. Suitable polyalkylene glycols include, for example, polyethylene glycols, polypropylene glycols, polytetrahydrofurans, and the like, and mixtures thereof. Polyalkylene glycols may be prepared by methods known in the art, including polymerization of the corresponding alkylene oxides, optionally in the presence of an initiating molecule such as an aliphatic diol (e.g., ethylene glycol, 1,3-propylene glycol, 1,2-propylene glycol, butylene glycols, pentane diols, and the like), an aliphatic triol (e.g., glycerol, trimethylolpropane, trimethylolhexane, and the like), a polyamine (e.g., tetraethylene diamine, and the like), or an alkanolamine (e.g., diethanolamine, triethanolamine, and the like). Polyalkylene glycols may also be prepared by polymerization of cyclic ethers, such as tetrahydrofuran. Polyalkylene glycols are commercially available, for example, from Sigma Aldrich, Alfa Aesar, or Huls AG.

The hydroxy-containing polymer may be a hydroxy-containing hydrocarbon polymer. The hydroxy-terminated hydrocarbon polymer is preferably a hydroxy-containing aliphatic hydrocarbon polymer. Suitable hydroxy-containing hydrocarbon polymers include, for example, hydroxy-terminated polybutadienes, hydroxy-terminated polyethylenes, hydroxy-terminated ethylene-butadiene copolymers, hydroxy-terminated propylene-butadiene copolymers, hydroxy-terminated polyisobutylene, hydroxy-functionalized derivatives produced by reacting a maleic anhydride grafted hydrocarbon resin with an alkylene polyol, and the like, hydrogenation products thereof, and mixtures thereof. Hydroxy-containing hydrocarbon polymers may be prepared according to methods known in the art. Hydroxy-containing hydrocarbon polymers may also be obtained commercially, including, for example, hydroxy-terminated polybutadienes from Atofina, and hydroxy-terminated polyethylene from Polymer Source.

The hydroxy-containing polymer may be a hydroxy-containing polyester. Hydroxy-containing polyesters may be formed by reacting a polycarboxylic acid with a polyhydric initiator, such as a diol or triol. Suitable polycarboxylic acids include, for example, oxalic acid, malonic acid, succinic acid, glutaric acid, adipic acid, pimelic acid, suberic acid, azelaic acid, and the like, and mixtures thereof. Suitable polyhydric alcohols include, for example, various diols and triols and higher functionality alcohols such as ethylene glycol, 1,3-propylene glycol, 1,2-propylene glycol, butylene glycols, pentane diols, glycerol, trimethylolpropane, trimethylolhexane, hexane-1,2,6-triol, and the like, and mixtures thereof. Hydroxy-containing polyesters are commercially available as, for example, KURAPOL P-2010, PMIPA, PKA-A, PKA-A2, and PNA-2000 (manufactured by Kuraray Co., Ltd.). Hydroxy-containing polyesters may also be prepared by the reaction of a polyol with a lactone, such as caprolactone, to form a higher molecular weight hydroxy-terminated polyester. For example, polycaprolactone diol compounds may be obtained by the reaction of ε-caprolactone and a divalent diol, such as ethylene glycol, polyethylene glycol, propylene glycol, polypropylene glycol, tetramethylene glycol, polytetramethylene glycol, 1,2-polybutylene glycol, 1,6-hexanediol, neopentyl glycol, 1,4-cyclohexanedimethanol, 1,4-butanediol, or the like. Such polycaprolactone diols are commercially available, as, for example, PLACCEL 205, 205AL, 212, 212AL, 220, 220AL (manufactured by Daicel Chemical Industries, Ltd.). Other polycaprolactone diols are commercially available from Union Carbide under the tradename TONE POLYOL as, for example, TONE 0200, 0221, 0301, 0310, 2201, and 2221.

The hydroxy-containing polymer may be a hydroxy-containing polycarbonate. Hydroxy-containing polycarbonates may be prepared by reacting the polyols discussed above and a carbonate precursor. The carbonate precursor may include phosgene, a haloformate, or a carbonate ester. For example, hydroxy-containing polycarbonates may be produced by the alcoholysis of diethyl carbonate with a diol. The diol can be, for example, an alkylene diol having 2 to about 12 carbon atoms, such as, for example, 1,4-butanediol, 1,6-hexanediol, 1,12-dodecanediol, and the like, and mixtures thereof. The polycarbonate diol can contain ether linkages in the backbone in addition to carbonate groups. Thus, for example, polycarbonate copolymers of the above described alkylene oxide monomers and the above described alkylene diols can be used. Polycarbonate diols are commercially available as, for example, the products of alcoholysis of diethyl carbonate with hexane diol sold as DURACARB® 122 (PPG Industries) and PERMANOL KM10-1733 (Permuthane, Inc.), as well as DN-980, DN-981, DN-982, and DN-983 (manufactured by Nippon Polyurethane Industry Co., Ltd.), PC-8000 (manufactured by PPG), and PC-THF-CD (manufactured by BASF).

When present, the hydroxy-containing polymer may be used in an amount of about 1 to about 40 parts by weight per 100 parts by weight total of the functionalized poly(arylene ether) and the olefinically unsaturated monomer. Within this range, the hydroxy-containing polymer amount may specifically be at least about 2 parts by weight, more specifically at least about 5 parts by weight. Also within this range, the hydroxy-containing polymer amount may specifically be up to about 30 parts by weight, more specifically up to about 20 parts by weight.

The curable composition may, optionally, comprise a polyisocyanate compound. The polyisocyanate compound may have the structure
R³⁰(NCO)ᵣ
wherein r is 2 to about 10, specifically 2 or 3 or 4, more specifically 2 or 3, still more specifically 2; and R³⁰ is a C₁-C₁₀₀ hydrocarbon radical, optionally substituted with heteroatoms, having a valence equal to r. In a preferred embodiment, the polyfunctional compound has the structure
O═C═N—R³¹—N═C═O
wherein R³¹ is C₁-C₁₈ hydrocarbylene, optionally substituted with heteroatoms. Preferably, R³¹ is C₆-C₁₈ arylene. Suitable polyisocyanate compounds include, for example, 2,4-tolylene diisocyanate, 2,6-tolylene diisocyanate, 1,3-xylylene diisocyanate, 1,4-xylylene diisocyanate, 1,5-naphthylene diisocyanate, m-phenylene diisocyanate, p-phenylene diisocyanate, 4-chloro-1,3-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,4-butylene-diisocyanate (also known as 1,4-tetramethylene diisocyanate), 1,6-hexylene diisocyanate (also known as 1,6-hexane diisocyanate or 1,6-hexamethylene diisocyanate), 1,10-decylene diisocyanate (also known as 1,10-decanediisocyanate or 1,10-decamethylene diisocyanate), 2,2,4-trimethyl hexamethylene diisocyanate, 1,3-cyclohexylene diisocyanate, 1,4-cyclohexylene diisocyanate, methylene dicyclohexane diisocyanate, isophorone diisocyanate, methylenebis(4-cyclohexyl)isocyanate, 2,2,4-trimethylhexamethylene diisocyanate, bis(2-isocyanate-ethyl) fumarate, 6-isopropyl-1,3-phenyl diisocyanate, 4-diphenylpropane diisocyanate, lysine diisocyanate, hydrogenated diphenylmethane diisocyanate, hydrogenated xylylene diisocyanate, tetramethylxylylene diisocyanate, 2,5-bis(isocyanatomethyl)-bicyclo[2.2.1]heptane, 2,6-bis(isocyanatomethyl)-bicyclo[2.2.1]heptane, polyalkyloxide and polyester glycol diisocyanates such as polytetramethylene ether glycol terminated with tolylene diisocyanate and polyethylene adipate terminated with tolylene diisocyanate, and the like, and mixtures thereof. Presently preferred diisocyanates include 2,4-tolylene diisocyanate, isophorone diisocyanate, xylylene diisocyanate, and methylenebis(4-cyclohexylisocyanate). Polyisocyanate compounds are known in the art and may be prepared by art-known procedures or obtained commercially.

When present, the polyisocyanate compound may be used in an amount of about 0.1 to about 20 parts by weight, based on 100 parts by weight total of the functionalized poly(arylene ether) and the olefinically unsaturated monomer. Within this range, the polyisocyanate amount may specifically be at least about 0.5 part by weight, more specifically at least about 1 part by weight. Also within this range, the polyisocyanate amount may specifically be up to about 10 parts by weight, more specifically up to about 5 parts by weight.

In one embodiment, the curable composition may comprise a hydroxy-containing polymer and a polyisocyanate compound. The hydroxy-containing polymer and the polyisocyanate compound may be used in a ratio such that the molar ratio of hydroxy groups on the hydroxy-containing polymer to isocyanate groups on the polyisocyanate compound is about 1:5 to about 5:1, specifically about 1:3 to about 3:1, more specifically about 1:2 to about 2:1. In this embodiment, the composition may further comprise an initiator for the reaction of hydroxy groups with isocyanate groups. Initiators for the isocyanate-hydroxy reaction include metal compounds, especially organotin compounds, that allow the reaction to proceed at a sufficient rate to increase the paste viscosity at a desired rate. Examples of such organotin compounds include dibutyl tin dilaurate, dibutyl tin diacetate, dibutyl tin oxide, and the like. An example of a suitable, commercially available organotin compound is dibutyl tin dilaurate available as Fastcat 4202 from M&T Chemicals. The metal compounds are typically employed in an amount of about 0.01 to about to about 1 by weight percent, based on the total weight of the composition. The initiators are useful to increase the viscosity of the curable composition without the application of external heat.

The curable composition may, optionally, further comprise a phase compatibilizing agent. The phase compatibilizing agent helps reduce phase separation in the curable composition. Suitable phase compatibilizing agents include C₅-C₃₀ fatty acids, C₂₀-C₅₄ dimer or trimer acids, polyalkyleneether polyols, copolymers of polyalkylene oxides and siloxanes, polyester polyols, polyvinyl ethers, polyvinyl esters, and the like, and mixtures thereof. Additional phase compatibilizing agents are described in U.S. Pat. No. 4,622,354 to Iseler et al. When present, the phase compatibilizing agent may be used in an amount of about 0.05 to about 2 parts by weight per 100 parts by weight total of the functionalized poly(arylene ether) and the olefinically unsaturated monomer.

The curable composition may, optionally, further comprise a flexibilizing agent. The addition of flexibilizing agent may improve the toughness, stiffness, and chip resistance of the cured composition. Suitable flexiblizing agents include, for example, polybutadienes, polystyrenes, polyolefins (e.g., polyethylenes, polypropylenes, ethylene-propylene copolymers), polystyrene-polybutadiene block copolymers, polyacrylonitriles, poly(alkyl (meth)acrylate)s (e.g., poly(methyl methacrylate)), polyvinyl ethers, polyvinyl acetates, and functionalized derivatives of the foregoing polymers, including hydroxy- and anhydride-functionalized derivatives. In one embodiment, the flexibilizing agent is selected from polystyrene-polybutadiene-polystyrene triblock copolymers, polystyrene-polyisoprene-polystyrene triblock copolymers, polystyrene-ethylene/butylene-polystyrene triblock copolymers, and mixtures thereof. As can be appreciated, such block copolymers may be linear, branched, or may include varying ratios of both. In one embodiment, the flexibilizing agent comprises polystyrene-polybutadiene-polystyrene triblock copolymer and polystyrene-polyisoprene-polystyrene triblock copolymer. In this embodiment, the polystyrene-polybutadiene-polystyrene triblock copolymer may be present at about 10 to about 40 weight percent of the total flexibilizing agent, and the polystyrene-polyisoprene-polystyrene triblock copolymer may be present at about 60 to about 90 weight percent of the total flexibilizing agent. It may be preferred to use a flexibilizing agent having a number average molecular weight less than 100,000 AMU, specifically less than 75,000 AMU. Examples include KRATON® G1855X (styrene-butadiene rubber), KRATON® D1300X (polystyrene-polybutadiene diblock and polystyrene-polybutadiene-polystyrene triblock), KRATON® MG1701X (polystyrene-poly(ethylene/propylene) diblock), and mixtures thereof. Suitable materials further include those supplied by Kaneka Corporation having varying compositions of methyl methacrylate-butadiene-styrene copolymers. Examples of these materials include those supplied under the designations Kane Ace B-56 impact modifier (70% butadiene), 52T264, MOD II (which generally has a high rubber content), and X52 NO2X (which generally has a high styrene content). When present, the flexibilizing agent may be used in an amount of about 0.1 to about 10 parts by weight per 100 parts by weight total of the functionalized poly(arylene ether) and the olefinically unsaturated monomer.

The curable composition may, optionally, further comprise a curing initiator. Curing initiators, also referred to as curing catalysts, are well known in the art and may be used to initiate the polymerization, curing, or crosslinking of numerous thermoplastics and thermosets including unsaturated polyester, vinyl ester and allylic thermosets. Non-limiting examples of curing initiators include those described in U.S. Pat. No. 5,407,972 to Smith et al., and U.S. Pat. No. 5,218,030 to Katayose et al. The curing initiator may include any compound capable of producing free radicals at elevated temperatures. Such curing initiators may include both peroxy and non-peroxy based radical initiators. Examples of useful peroxy initiators include, for example, benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, α,α′-bis(t-butylperoxy-m-isopropyl)benzene, 2,5-dimethyl-2,5-di(t-butylperoxy)hexane, di(t-butylperoxy) isophthalate, t-butylperoxy benzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, and the like, and mixtures thereof. Suitable non-peroxy initiators include, for example, 2,3-dimethyl-2,3-diphenylbutane, 2,3-bis(trimethylsilyloxy)-2,3-diphenylbutane, and the like, and mixtures thereof. The curing initiator for the unsaturated portion of the thermoset may further include any compound capable of initiating anionic polymerization of the unsaturated components. Such anionic polymerization initiators include, for example, alkali metal amides, such as sodium amide (NaNH₂) and lithium diethyl amide (LiN(C₂H₅)₂); alkali metal and ammonium salts of C₁-C₁₀ alkoxides; alkali metal and ammonium hydroxides; alkali metal cyanides; organometallic compounds such as the alkyl lithium compound n-butyl lithium; Grignard reagents such as phenyl magnesium bromide; and the like; and combinations thereof. In a preferred embodiment, the curing initiator may comprise t-butylperoxy benzoate or dicumyl peroxide. The curing initiator may promote curing at a temperature in a range of about 0° C. to about 200° C. When present, the curing initiator may be used at about 0.1 to about 5 parts by weight per 100 parts by weight total of the functionalized poly(arylene ether) and the olefinically unsaturated monomer. Within this range, the curing initiator amount may specifically be at least about 0.5 part by weight, more specifically at least about 1 part by weight. Also within this range, the curing initiator amount may specifically be up to about 4 parts by weight, more specifically up to about 3 parts by weight. Alternatively, the curing initiator amount may be expressed in units of micromoles per gram of resin, where “resin” consists of the functionalized poly(arylene ether) and the olefinically unsaturated monomer. In this embodiment, the curing initiator amount is preferably at least about 100 micromoles per gram of resin.

The curable composition may, optionally, comprises one or more thermoset additives known in the art. Suitable additives include, for example, impact modifiers, dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, and the like, and combinations thereof.

One embodiment is a method of compression molding a curable composition, comprising: introducing a curable poly(arylene ether) composition into a compression mold; closing the mold a first time and applying to the curable poly(arylene ether) composition a first temperature of about 130 to about 170° C. and a first pressure of about 2,000 to about 20,000 kilopascals for about 5 to about 60 seconds; opening the mold for about 0.01 to about 1 second; and closing the mold a second time and applying to the curable poly(arylene ether) composition a second temperature of about 130 to about 170° C. and a second pressure about 2,000 to about 20,000 kilopascals for about 60 to about 90 seconds to mold and cure the composition; wherein the curable poly(arylene ether) composition comprises a (meth)acrylate-capped poly(arylene ether) resin, an acryloyl monomer comprising at least two acryloyl moieties, and a filler.

Another embodiment is a method of compression molding a curable composition, comprising: introducing a curable poly(arylene ether) composition into a compression mold; closing the mold a first time and applying to the curable poly(arylene ether) composition a first temperature of about 140 to about 160° C. and a first pressure of about 4,000 to about 10,000 kilopascals for about 10 to about 30 seconds; opening the mold for about 0.01 to about 0.1 second; and closing the mold a second time and applying to the curable poly(arylene ether) composition a second temperature of about 140 to about 160° C. and a second pressure of about 4,000 to about 10,000 kilopascals for about 30 to about 60 seconds to mold and cure the composition; wherein the curable poly(arylene ether) composition comprises a functionalized poly(arylene ether) comprising a (meth)acrylate-monocapped poly(2,6-dimethyl-1,4-phenylene ether) resin or a (meth)acrylate-dicapped poly(2,6-dimethyl-1,4-phenylene ether) resin having an intrinsic viscosity of about 0.2 to about 0.3 deciliters per gram measured at 25° C. in chloroform, an acryloyl monomer selected from trimethylolpropane tri(meth)acrylate, ethoxylated trimethylolpropane tri(meth)acrylate, and mixtures thereof, and a filler.

There is no particular limitation on the method by which the composition is prepared. The composition may be prepared by forming an intimate blend comprising the functionalized poly(arylene ether), the olefinically unsaturated monomer, and the filler. When the poly(arylene ether) is a capped poly(arylene ether), the composition may be prepared directly from an unfunctionalized poly(arylene ether) by dissolving the uncapped poly(arylene ether) in a portion of the olefinically unsaturated monomer, adding a capping agent to form the capped poly(arylene ether) in the presence of the olefinically unsaturated monomer, and adding the remaining components to form the curable composition.

As the composition is defined as comprising multiple components, it will be understood that each component is chemically distinct, particularly in the instance that a single chemical compound may satisfy the definition of more than one component.

There is no particular limitation on the method by which the composition may be cured. The composition may, for example, be cured thermally or by using irradiation techniques, including UV irradiation and electron beam irradiation. When heat curing is used, the temperature selected may be about 80° to about 300° C. Within this range, the temperature may specifically be at least about 120° C. Also within this range, the temperature may specifically be up to about 240° C. The heating period may be about 30 seconds to about 24 hours. Within this range, the heating time may specifically be at least about 1 minute, more specifically at least about 2 minutes. Also within this range, the heating time may specifically be up to about 10 hours, more specifically about 5 hours, yet more specifically up to about 3 hours. Such curing may be staged to produce a partially cured and often tack-free resin, which then is fully cured by heating for longer periods or temperatures within the aforementioned ranges. Thermal curing may be conducted in stages, e.g., by conducting initial curing during molding and subsequent curing (so-called “post-curing”) thereafter.

One embodiment is a cured composition obtained by curing any of the above-described curable compositions. Because the components of the curable composition may react with each other during curing, the cured compositions may be described as comprising the reaction product of the curable composition components.

One embodiment is a molded article prepared from any of the above curable compositions according to any of the above methods. The molded articles are particularly useful for their dielectric properties. For example, the molded article may have an impulse breakdown voltage of at least 90 kilovolts, specifically at least 100 kilovolts, more specifically at least 110 kilovolts, measured according to the procedure described in the working examples below.

The invention is further illustrated by the following non-limiting examples.

### EXAMPLES 1-6

Five compositions varying in acryloyl monomer type, polymeric additive type, filler type, and mold release agent type, were prepared according to the procedures described above. A capped poly(2,6-dimethyl-1,4-phenylene ether) having an intrinsic viscosity of 0.15 dL/g was prepared according to the procedure described in Preparative Examples 1-4 of U.S. Pat. No. 6,627,704 B2 to Yeager et al. Dipropylene glycol diacrylate was obtained as SR508 from Sartomer. Ethoxylated bisphenol A dimethacrylate was obtained as SR348 from Sartomer. A maleinized polybutadiene (polybutadiene-graft-maleic anhydride) having a number average molecular weight of about 8,300 and a total acid value of about 5 weight percent was obtained as RICON® 131MA5 from Sartomer. A polybutadiene having a number average molecular weight of 8,000 atomic mass units was obtained as RICON® 134 from Sartomer.

Samples were injection molded at a mold temperature of 320° F. (160° C.) and barrel temperatures of 120-140° F. (48.9-60.0° C.). The total cure time was about 60 to about 85 seconds. The injection time was typically less than one second. Dielectric breakdown strengths were measured according to ASTM D149.

Compositions and properties are summarized in Table 1. All component amounts are expressed in parts by weight. The results show that Examples 3-6 exhibit reduced shrinkage compared to Example 1. The results also show that Examples 5 and 6 exhibit improved (higher) dielectric strengths compared to Example 1.

TABLE 1

| | Ex. 1 | Ex. 2 | Ex. 3 | Ex. 4 | Ex. 5 | Ex. 6 |
|---|---|---|---|---|---|---|
| Composition | | | | | | |
| MAA-PPE, IV = 0.15 | 19.25 | 19.17 | 17.57 | 17.57 | 19.17 | 19.17 |
| Dipropylene glycol diacrylate | 5.13 | 5.11 | 0 | 0 | 5.11 | 5.11 |
| Ethoxylated bisphenol A dimethacrylate | 0 | 0 | 6.72 | 6.72 | 0 | 0 |
| Glass fiber | 20 | 20 | 20 | 20 | 20 | 20 |
| Styrene | 2.55 | 2.55 | 2.55 | 0 | 0 | 2.55 |
| Maleinized polybutadiene | 0 | 0 | 0 | 2.55 | 2.55 | 0 |
| Polybutadiene | 20 | 20 | 20 | 20 | 20 | 20 |
| t-Butyl peroxybenzoate | 0.51 | 0.51 | 0.51 | 0.51 | 0.51 | 0.51 |
| Ricon 131MA5 | 1.42 | 1.42 | 1.42 | 1.42 | 1.42 | 1.42 |
| Magnesium Oxide | 0.09 | 0.25 | 0.25 | 0.25 | 0.25 | 0.25 |
| Aluminum trihydrate | 50 | 25 | 50 | 50 | 50 | 50 |
| Calcium carbonate | 0 | 25 | 0 | 0 | 0 | 0 |
| Calcium stearate | 1.03 | 1 | 1 | 1 | 1 | 0 |
| Zinc stearate | 0 | 0 | 0 | 0 | 0 | 1 |
| Properties | | | | | | |
| Shrinkage (mils/inch) | 1.83 | 2.22 | 1.31 | 0.58 | 0.71 | 0.88 |
| Dielectric strength (V/mil) | 454 ± 32 | 426 ± 4 | 445 ± 14 | 445 ± 12 | 466 ± 11 | 456 ± 14 |

### EXAMPLES 7-26

Twenty compositions were prepared and compression molded into 12 inch by 12 inch plaques. Compositions and molding conditions are summarized in Table 2. Neopentyl glycol dimethacrylate was obtained from Sartomer as SR248. Micronized polyethylene was obtained from Equistar Corporation as FN510. A polybutadiene having a number average molecular weight of 4,500 atomic mass units was obtained as RICON® 131 from Sartomer. Glass fibers were obtained from Owens Corning as 101C.

The molding variables were mold temperature; clamp speed, which corresponds to the speed with which the mold is closed (the reciprocal of clamp speed is the time taken to close the mold); breathe delay, which is the time for which the mold is completely closed before opening to release any gas build-up; breathe dwell, which is the time for which the mold is open after the delay period; and clamp pressure, which is the pressure applied to the composition during the breathe delay and the molding period. The total cycle time for this molding process is 60-120 sec, which includes the times from which mold is first closed, breathe, dwell, and the second time when the mold is closed.

Arc resistance was measured according to ASTM D495. Dielectric strength was measured according to ASTM D149 at 2.5 kilovolts per second. Flexural modulus was measured at 25° C. according to ASTM D790. Tensile strength and modulus were measured according to ASTM D638.

Dielectric breakdown voltage (also known as impulse breakdown voltage) was measured on samples having a thickness of 3.175 millimeters (one-eighth inch). The dielectric breakdown voltage was performed using a pass/fail test at pre-set voltage levels. The waveform approximates the 1.2/50 impulse waveform and was performed using a negative going wave. The samples were tested under oil (DK7) using a 2 inch brass ground electrode and a 1 inch stainless steel high voltage electrode. Both electrodes were Rogowski profiled with broken edges to avoid high electrical fields. The gap setting of the spheres on the generator was set to provide the given voltage at that test level. The voltage levels were successively increased in steps until the sample failed. The starting voltage was set at 80 kilovolts (kV) with steps of 10 kV until 130 kV at which steps were reduced to 5 kV. The general test procedure is summarized in the following steps:
1) The generator is tested under open circuit to confirm the voltage level. Generally two shots can be obtained from a particular gap configuration.
2) The sample is inserted between the electrodes under oil.
3) The sample is stressed with the impulse.
4) The withstand voltage of the sample is recorded or if the sample failed, it is recorded as a flashover or failure.
5) If the sample passes, it is again stressed with the higher voltage of this gap setting.
6) Step 5 continues until the sample fails, or the top voltage of that gap setting is reached.
7) The first sample is removed and set aside and the next sample is placed between the electrodes.
8) Steps 3-6 are repeated until all samples are tested at this gap setting (voltage level).
9) The gaps are reset to move to higher voltage levels.
10) Steps 1-9 are repeated until all samples have failed.
11) Reported values represent the last withstand voltage that the sample exhibited. In other words, that is the last level at which the material passed—holding off the voltage.

Property results are summarized in Table 2. The results show that, particularly for the capped poly(arylene ether) with an intrinsic viscosity of 0.25 dL/g, impulse breakdown voltage is significantly influenced by mold temperature and breathe delay, with increases in each of these variables being correlated with an increase in impulse breakdown voltage. In addition, the interaction of clamp speed & mold pressure influences the impulse breakdown voltage, with a lower value of the product of clamp speed & mold pressure correlated with an increase in impulse breakdown voltage.

TABLE 2

| | Ex. 7 | Ex. 8 | Ex. 9 | Ex. 10 |
|---|---|---|---|---|
| Composition | | | | |
| MAA-PPE, IV = 0.25 | 9.3 | 9.3 | 9.3 | 9.3 |
| (pbw) | | | | |
| MAA-PPE, IV = 0.15 | 0 | 0 | 0 | 0 |
| (pbw) | | | | |
| Neopentyl glycol | 4.8 | 4.8 | 4.8 | 4.8 |
| dimethacrylate (pbw) | | | | |
| Dipropylene glycol | 0 | 0 | 0 | 0 |
| diacrylate (pbw) | | | | |
| Styrene (pbw) | 18.1 | 18.1 | 18.1 | 18.1 |
| Maleinized polybuta- | 1.6 | 1.6 | 1.6 | 1.6 |
| diene (pbw) | | | | |
| Magnesium oxide (pbw) | 0.4 | 0.4 | 0.4 | 0.4 |
| t-Butyl peroxybenzoate | 0.8 | 0.8 | 0.8 | 0.8 |
| (pbw) | | | | |
| Aluminum trihydrate | 35.0 | 35.0 | 35.0 | 35.0 |
| (pbw) | | | | |
| Micronized polyethylene | 4.0 | 4.0 | 4.0 | 4.0 |
| (pbw) | | | | |
| Polybutadiene (pbw) | 0 | 0 | 0 | 0 |
| Calcium stearate (pbw) | 1.0 | 1.0 | 1.0 | 1.0 |
| Glass fiber (pbw) | 25.0 | 25.0 | 25.0 | 25.0 |
| Molding Conditions | | | | |
| Temperature (° C.) | 148.9 | 148.9 | 148.9 | 148.9 |
| Clamp Speed (1/sec) | 0.5 | 0.2 | 0.5 | 0.2 |
| Breathe dwell (sec) | 0.05 | 0.01 | 0.05 | 0.01 |
| Breathe delay (sec) | 24 | 24 | 12 | 12 |
| Pressure (kilopascals) | 4,788 | 4,788 | 9,576 | 9,576 |
| Properties | | | | |
| Arc resistance (sec) | 134.2 | 95.8 | 96.0 | 100.6 |
| Dielectric strength | 427.8 | 424.3 | 388.6 | 426.8 |
| (V/mil) | | | | |
| Flexural strength (psi) | 15245 | 14573 | 15256 | 15315 |
| Flexural modulus (Mpsi) | 0.66 | 0.68 | 0.65 | 0.79 |
| Tensile Strength (psi) | 5084 | 5189 | 5945 | 5348 |
| Tensile modulus (Mpsi) | 1.30 | 1.27 | 1.29 | 1.14 |
| Impulse breakdown | 118 | 125 | 87 | 113 |
| voltage (kV) | | | | |
| | Ex. 11 | Ex. 12 | Ex. 13 | Ex. 14 |
| Composition | | | | |
| MAA-PPE, IV = 0.25 | 9.3 | 9.3 | 9.3 | 9.3 |
| (pbw) | | | | |
| MAA-PPE, IV = 0.15 | 0 | 0 | 0 | 0 |
| (pbw) | | | | |
| Neopentyl glycol | 4.8 | 4.8 | 4.8 | 4.8 |
| dimethacrylate (pbw) | | | | |
| Dipropylene glycol | 0 | 0 | 0 | 0 |
| diacrylate (pbw) | | | | |
| Styrene (pbw) | 18.1 | 18.1 | 18.1 | 18.1 |
| Maleinized polybuta- | 1.6 | 1.6 | 1.6 | 1.6 |
| diene (pbw) | | | | |
| Magnesium oxide (pbw) | 0.4 | 0.4 | 0.4 | 0.4 |
| t-Butyl peroxybenzoate | 0.8 | 0.8 | 0.8 | 0.8 |
| (pbw) | | | | |
| Aluminum trihydrate | 35.0 | 35.0 | 35.0 | 35.0 |
| (pbw) | | | | |
| Micronized polyethylene | 4.0 | 4.0 | 4.0 | 4.0 |
| (pbw) | | | | |
| Polybutadiene (pbw) | 0 | 0 | 0 | 0 |
| Calcium stearate (pbw) | 1.0 | 1.0 | 1.0 | 1.0 |
| Glass fiber (pbw) | 25.0 | 25.0 | 25.0 | 25.0 |
| Molding Conditions | | | | |
| Temperature (° C.) | 162.8 | 162.8 | 162.8 | 162.8 |
| Clamp Speed (1/sec) | 0.5 | 0.2 | 0.5 | 0.2 |
| Breathe dwell (sec) | 0.05 | 0.05 | 0.05 | 0.01 |
| Breathe delay (sec) | 24 | 12 | 12 | 12 |
| Pressure (kilopascals) | 9,576 | 9,576 | 4,788 | 4,788 |
| Properties | | | | |
| Arc resistance (sec) | 134.9 | 136.2 | 136.9 | 135.1 |
| Dielectric strength | 420.4 | 431.3 | 390.4 | 445.0 |
| (V/mil) | | | | |
| Flexural strength (psi) | 15518 | 13673 | 14006 | 15629 |
| Flexural modulus (Mpsi) | 0.74 | 0.73 | 0.67 | 0.72 |
| Tensile Strength (psi) | 5166 | 5408 | 5785 | 5269 |
| Tensile modulus (Mpsi) | 1.18 | 1.24 | 1.28 | 1.30 |
| Impulse breakdown | 123 | 125 | 112 | 112 |
| voltage (kV) | | | | |
| | Ex. 15 | Ex. 16 | Ex. 17 | Ex. 18 |
| Composition | | | | |
| MAA-PPE, IV = 0.25 | 9.3 | 9.3 | 0 | 0 |
| (pbw) | | | | |
| MAA-PPE, IV = 0.15 | 0 | 0 | 9.47 | 9.47 |
| (pbw) | | | | |
| Neopentyl glycol | 4.8 | 4.8 | 0 | 0 |
| dimethacrylate (pbw) | | | | |
| Dipropylene glycol | 0 | 0 | 5.132 | 5.132 |
| diacrylate (pbw) | | | | |
| Styrene (pbw) | 18.1 | 18.1 | 9.79 | 9.79 |
| Maleinized polybuta- | 1.6 | 1.6 | 1.429 | 1.429 |
| diene (pbw) | | | | |
| Magnesium oxide (pbw) | 0.4 | 0.4 | 0.086 | 0.086 |
| t-Butyl peroxybenzoate | 0.8 | 0.8 | 0.513 | 0.513 |
| (pbw) | | | | |
| Aluminum trihydrate | 35.0 | 35.0 | 50.0 | 50.0 |
| (pbw) | | | | |
| Micronized polyethylene | 4.0 | 4.0 | 0 | 0 |
| (pbw) | | | | |
| Polybutadiene (pbw) | 0 | 0 | 2.566 | 2.566 |
| Calcium stearate (pbw) | 1.0 | 1.0 | 1.026 | 1.026 |
| Glass fiber (pbw) | 25.0 | 25.0 | 20.0 | 20.0 |
| Molding Conditions | | | | |
| Temperature (° C.) | 162.8 | 162.8 | 162.8 | 162.8 |
| Clamp Speed (1/sec) | 0.5 | 0.2 | 0.5 | 0.2 |
| Breathe dwell (sec) | 0.05 | 0.01 | 0.05 | 0.01 |
| Breathe delay (sec) | 24 | 12 | 24 | 24 |
| Pressure (kilopascals) | 9,576 | 4,788 | 4,788 | 4,788 |
| Properties | | | | |
| Arc resistance (sec) | 97.8 | 94.8 | — | — |
| Dielectric strength | 426.1 | 448.4 | — | — |
| (V/mil) | | | | |
| Flexural strength (psi) | 14530 | 15980 | 10737 | 12049 |
| Flexural modulus (Mpsi) | 0.77 | 0.77 | 1.02 | 1.09 |
| Tensile Strength (psi) | 5602 | 5147 | 3914 | 3513 |
| Tensile modulus (Mpsi) | 1.22 | 1.23 | 1.46 | 1.25 |
| Impulse breakdown | 130 | 117 | 87 | 98 |
| voltage (kV) | | | | |
| | Ex. 19 | Ex. 20 | Ex. 21 | Ex. 22 |
| Composition | | | | |
| MAA-PPE, IV = 0.25 | 0 | 0 | 0 | 0 |
| (pbw) | | | | |
| MAA-PPE, IV = 0.15 | 9.47 | 9.47 | 9.47 | 9.47 |
| (pbw) | | | | |
| Neopentyl glycol | 0 | 0 | 0 | 0 |
| dimethacrylate (pbw) | | | | |
| Dipropylene glycol | 5.132 | 5.132 | 5.132 | 5.132 |
| diacrylate (pbw) | | | | |
| Styrene (pbw) | 9.79 | 9.79 | 9.79 | 9.79 |
| Maleinized polybuta- | 1.429 | 1.429 | 1.429 | 1.429 |
| diene (pbw) | | | | |
| Magnesium oxide (pbw) | 0.086 | 0.086 | 0.086 | 0.086 |
| t-Butyl peroxybenzoate | 0.513 | 0.513 | 0.513 | 0.513 |
| (pbw) | | | | |
| Aluminum trihydrate | 50.0 | 50.0 | 50.0 | 50.0 |
| (pbw) | | | | |
| Micronized polyethylene | 0 | 0 | 0 | 0 |
| (pbw) | | | | |
| Polybutadiene (pbw) | 2.566 | 2.566 | 2.566 | 2.566 |
| Calcium stearate (pbw) | 1.026 | 1.026 | 1.026 | 1.026 |
| Glass fiber (pbw) | 20.0 | 20.0 | 20.0 | 20.0 |
| Molding Conditions | | | | |
| Temperature (° C.) | 162.8 | 162.8 | 162.8 | 176.7 |
| Clamp Speed (1/sec) | 0.5 | 0.2 | 0.5 | 0.5 |
| Breathe dwell (sec) | 0.05 | 0.01 | 0.01 | 0.05 |
| Breathe delay (sec) | 12 | 12 | 24 | 24 |
| Pressure (kilopascals) | 9,576 | 9,576 | 9,576 | 9,576 |
| Properties | | | | |
| Arc resistance (sec) | — | — | — | — |
| Dielectric strength | — | — | — | — |
| (V/mil) | | | | |
| Flexural strength (psi) | 12822 | 12904 | 12482 | 11163 |
| Flexural modulus (Mpsi) | 1.10 | 1.10 | 1.10 | 1.12 |
| Tensile Strength (psi) | 4122 | 4189 | 3661 | 5825 |
| Tensile modulus (Mpsi) | 1.44 | 1.55 | 1.45 | 1.49 |
| Impulse breakdown | 93 | 100 | 100 | 100 |
| voltage (kV) | | | | |
| | Ex. 23 | Ex. 24 | Ex. 25 | Ex. 26 |
| Composition | | | | |
| MAA-PPE, IV = 0.25 | 0 | 0 | 0 | 0 |
| (pbw) | | | | |
| MAA-PPE, IV = 0.15 | 9.47 | 9.47 | 9.47 | 9.47 |
| (pbw) | | | | |
| Neopentyl glycol | 0 | 0 | 0 | 0 |
| dimethacrylate (pbw) | | | | |
| Dipropylene glycol | 5.132 | 5.132 | 5.132 | 5.132 |
| diacrylate (pbw) | | | | |
| Styrene (pbw) | 9.79 | 9.79 | 9.79 | 9.79 |
| Maleinized polybuta- | 1.429 | 1.429 | 1.429 | 1.429 |
| diene (pbw) | | | | |
| Magnesium oxide (pbw) | 0.086 | 0.086 | 0.086 | 0.086 |
| t-Butyl peroxybenzoate | 0.513 | 0.513 | 0.513 | 0.513 |
| (pbw) | | | | |
| Aluminum trihydrate | 50.0 | 50.0 | 50.0 | 50.0 |
| (pbw) | | | | |
| Micronized polyethylene | 0 | 0 | 0 | 0 |
| (pbw) | | | | |
| Polybutadiene (pbw) | 2.566 | 2.566 | 2.566 | 2.566 |
| Calcium stearate (pbw) | 1.026 | 1.026 | 1.026 | 1.026 |
| Glass fiber (pbw) | 20.0 | 20.0 | 20.0 | 20.0 |
| Molding Conditions | | | | |
| Temperature (° C.) | 176.7 | 176.7 | 176.7 | 176.7 |
| Clamp Speed (1/sec) | 0.2 | 0.5 | 0.2 | 0.5 |
| Breathe dwell (sec) | 0.05 | 0.05 | 0.01 | 0.05 |
| Breathe delay (sec) | 12 | 12 | 12 | 24 |
| Pressure (kilopascals) | 9,576 | 4,788 | 4,788 | 9,576 |
| Properties | | | | |
| Arc resistance (sec) | — | — | — | — |
| Dielectric strength | — | — | — | — |
| (V/mil) | | | | |
| Flexural strength (psi) | 12265 | 14519 | 12153 | 13426 |
| Flexural modulus (Mpsi) | 1.25 | 1.21 | 1.24 | 1.18 |
| Tensile Strength (psi) | 4357 | 3726 | 3157 | 3683 |
| Tensile modulus (Mpsi) | 1.67 | 1.46 | 1.38 | 1.43 |
| Impulse breakdown | 103 | 93 | 80 | 90 |
| voltage (kV) | | | | |

### EXAMPLES 27-33

Several compositions, each employing a different polymeric additive, were prepared and tested. A solution containing 35 weight percent methacrylate-capped poly(2,6-dimethyl-1,4-phenylene ether), intrinsic viscosity=0.25 dL/g, in styrene was prepared according to the procedure described in Preparative Example 5 of U.S. Pat. No. 6,627,704 B2 to Yeager et al. Trimethylolpropane trimethacrylate was obtained as SR350 from Sartomer. A high density polyethylene powder having a melt index of 10 grams/minute (g/min), an average particle size of 20 micrometers, and a bulk density of 0.952 grams/milliliter (g/mL) was obtained from Equistar as FA 700; a flow-enhanced high density polyethylene powder having a melt index of 10 grams/minute (g/min), an average particle size of 20 micrometers, and a bulk density of 0.952 grams/milliliter (g/mL) was obtained from Equistar as FA 709; a low density polyethylene powder having a melt index of 23 g/min, an average particle size of 20 micrometers, and a bulk density of 0.9245 g/mL was obtained from Equistar as FN 510; a polypropylene powder having a melt index of 35 g/min, an average particle size of 20 micrometers, and a bulk density of 0.909 g/mL was obtained from Equistar as FP 800; a flow-enhanced polypropylene powder having a melt index of 35 g/min, an average particle size of 20 micrometers, and a bulk density of 0.909 g/mL was obtained from Equistar as FP 809; an ethylene-vinyl acetate copolymer powder having a melt index of 9.5 g/min, an average particle size of 20 micrometers, and a bulk density of 0.926 g/mL was obtained from Equistar as FE 532. Glass fibers having an initial length of one-quarter inch were obtained as Owens Corning Chopped Fiberglass Grade 101C.

Samples were prepared as follows. A 35% weight/weight (w/w) solution of methacrylate-capped poly(2,6-dimethyl-1,4-phenylene ether) in styrene was combined with trimethylolpropane trimethacrylate in the amounts shown in Table 3. The solution became fluid after heating to approximately 40-70° C. Zinc stearate, calcium carbonate, and the powdered polymeric additive were then added and the solution was stirred vigorously. The peroxide was then added, and the pasty solution was mixed with glass fibers in a mixing bowl to yield the bulk molding compound. Test samples were molded at 150° C. and 1,200 pounds per square inch (psi). Shrinkage, expressed in percent, was measured by comparing the length of the molded sample to the length of the mold, both at 25° C. Flexural strength, expressed in pounds per square inch (psi), was measured at 25° C. according to ASTM D790. Dynatup normalized energy was measured at 25° C. according to ASTM 3763. Compositions and results are summarized in Table 3. The results show that Examples 28-33, with powdered polyolefin additive, each exhibit reduced shrinkage compared to Example 27, with no additive. The results also show that Examples 30, 32, and 33 exhibit improved (higher) flexural strength than the Example 27 control. The results further show that Example 32 exhibits improved (higher) normalized energy than the Example 1 control.

TABLE 3

| | Ex. 27 | Ex. 28 | Ex. 29 | Ex. 30 | Ex. 31 | Ex. 32 | Ex. 33 |
|---|---|---|---|---|---|---|---|
| Composition | | | | | | | |
| 35% (w/w) solution of MAA-PPE in styrene | 347.7 | 325.5 | 325.5 | 325.5 | 325.5 | 325.5 | 325.5 |
| Trimethylolpropane trimethacrylate | 81.8 | 76.6 | 76.6 | 76.6 | 76.6 | 76.6 | 76.6 |
| HDPE powder, FA 700 | 0 | 28.7 | 0 | 0 | 0 | 0 | 0 |
| HDPE powder FA 709 | 0 | 0 | 28.7 | 0 | 0 | 0 | 0 |
| LDPE powder, FN 510 | 0 | 0 | 0 | 28.7 | 0 | 0 | 0 |
| polypropylene powder, FP 800 | 0 | 0 | 0 | 0 | 28.7 | 0 | 0 |
| polypropylene powder, FP 809 | 0 | 0 | 0 | 0 | 0 | 28.7 | 0 |
| ethylene-vinyl acetate copolymer powder, FE 532 | 0 | 0 | 0 | 0 | 0 | 0 | 28.7 |
| t-Butyl peroxybenzoate | 8.2 | 7.7 | 7.7 | 7.7 | 7.7 | 7.7 | 7.7 |
| Zinc stearate | 12.3 | 11.7 | 11.7 | 11.7 | 11.7 | 11.7 | 11.7 |
| Calcium Carbonate | 900 | 900 | 900 | 900 | 900 | 900 | 900 |
| Glass fiber | 337.5 | 337.5 | 337.5 | 337.5 | 337.5 | 337.5 | 337.5 |
| Properties | | | | | | | |
| Shrinkage (%) | 0.0300 | 0.0014 | 0.0014 | 0.0013 | 0.0013 | 0.0014 | 0.0014 |
| Flexural strength (psi) | 11371 | 10081 | 9894 | 12507 | 8523 | 14002 | 11948 |
| Normalized energy (in-lb/in) | 24.0 | 17.0 | 18.3 | 23.7 | 10.6 | 30.3 | 22.5 |

### EXAMPLES 34-40

Several compositions, varying in the type of polyol or polyether polyol additive, were prepared according to the methods described above. A solution containing 35 weight percent methacrylate-capped poly(2,6-dimethyl-1,4-phenylene ether), intrinsic viscosity=0.30 dL/g, in styrene was prepared according to the procedure described in Preparative Example 5 of U.S. Pat. No. 6,627,704 B2 to Yeager et al. A polytetrahydrofuran having a weight average molecular weight of 2,000 AMU was obtained from Aldrich Chemical Company. A polytetrahydrofuran having a number average molecular weight of 2,800 AMU was obtained from Aldrich Chemical Company. A block tetrahydrofuran/caprolactone copolymer having a number average molecular weight of 2,000 AMU was obtained from Aldrich Chemical Company. A polypropylene glycol having a number average molecular weight of 2,000 AMU was obtained from Aldrich Chemical Company. A hydroxy-terminated polybutadiene was obtained as from Aldrich Chemical Company.

Viscosities were measured at 1 sec⁻¹, 10 sec, and 100 sec⁻¹ using a Brookfield viscometer. Compositions and properties are summarized in Table 3. In the table, viscosities are expressed in units of centipoises (cP). The results show that Examples 36-40, containing a polyether or polyol additive, exhibit substantially reduced viscosity and viscosity shear-dependence compared to Example 34 with no additive. The large and unexpected magnitude of this effect is illuminated by the results for Example 35, which contains styrene and exhibits markedly higher viscosity and shear-dependence than Examples 36-40.

TABLE 3

| | Ex. 34 | Ex. 35 | Ex. 36 | Ex. 37 | Ex. 38 | Ex. 39 | Ex. 40 |
|---|---|---|---|---|---|---|---|
| Composition | | | | | | | |
| 35% (w/w) solution of MAA-PPE in styrene (pbw) | 85 | 85 | 85 | 85 | 85 | 85 | 85 |
| Ethylene glycol dimethacrylate (pbw) | 20 | 20 | 20 | 20 | 20 | 20 | 20 |
| Styrene (pbw) | 0 | 5 | 0 | 0 | 0 | 0 | 0 |
| Polytetrahydrofuran, M_{w} = 2000 (pbw) | 0 | 0 | 5 | 0 | 0 | 0 | 0 |
| Polytetrahydrofuran, Mₙ = 2800 (pbw) | 0 | 0 | 0 | 5 | 0 | 0 | 0 |
| Tetrahydrofuran/caprolactone block copolymer, Mₙ = 2800 (pbw) | 0 | 0 | 0 | 0 | 5 | 0 | 0 |
| Poly(propylene glycol), Mₙ = 2900 (pbw) | 0 | 0 | 0 | 0 | 0 | 5 | 0 |
| Hydroxy-terminated butadiene (pbw) | 0 | 0 | 0 | 0 | 0 | 0 | 5 |
| t-Butyl peroxybenzoate (pbw) | 2 | 2 | 2 | 2 | 2 | 2 | 2 |
| Properties | | | | | | | |
| Viscosity at 1 sec⁻¹ (cP) | 105,000 | 41,000 | 1,510 | 2,390 | 1,540 | 4,400 | 3,850 |
| Viscosity at 10 sec⁻¹ (cP) | 24,100 | 4,000 | 731 | 1,050 | 528 | 1,040 | 1,210 |
| Viscosity at 100 sec⁻¹ (cP) | 2,850 | 1,190 | 504 | 734 | 385 | 490 | 740 |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety.

1. A method of compression molding a curable composition, comprising:
introducing a curable poly(arylene ether) composition into a compression mold;
closing the mold a first time and applying to the curable poly(arylene ether) composition a first temperature of about 120 to about 200° C. and a first pressure of about 1,000 to about 40,000 kilopascals for about 1 to about 100 seconds;
opening the mold for about 0.005 to about 10 seconds; and
closing the mold a second time and applying to the curable poly(arylene ether) composition a second temperature of about 120 to about 200° C. and a second pressure of about 1,000 to about 40,000 kilopascals for about 20 to about 100 seconds;
wherein the curable poly(arylene ether) composition comprises
a functionalized poly(arylene ether) resin,
an olefinically unsaturated monomer, and
a filler.

2. The method of claim 1, wherein the first temperature is about 130 to about 170° C.

3. The method of claim 1, wherein the first pressure is about 2,000 to about 20,000 kilopascals.

4. The method of claim 1, wherein said applying to the curable poly(arylene ether) composition a first temperature and a first pressure is for about 5 to about 60 seconds.

5. The method of claim 1, wherein said opening the mold is for about 0.01 to about 1 second.

6. The method of claim 1, wherein the second temperature is about 130 to about 170° C.

7. The method of claim 1, wherein the second pressure is about 2,000 to about 20,000 kilopascals.

8. The method of claim 1, wherein said applying to the curable poly(arylene ether) composition a second temperature and a second pressure is for about 30 to about 80 seconds.

9. The method of claim 1, wherein said closing the mold the first time is characterized by a clamp speed of about 0.05 to about 2 sec⁻¹.

10. The method of claim 1, wherein the functionalized poly(arylene ether) resin has an intrinsic viscosity of about 0.05 to about 0.8 deciliters per gram at 25° C. in chloroform.

11. The method of claim 1, wherein the functionalized poly(arylene ether) resin is a capped poly(arylene ether) resin having the formula
Q(J-K)_{y}
wherein Q is the residuum of a monohydric, dihydric, or polyhydric phenol; y is 1 to 100; J comprises repeating structural units and has the formula 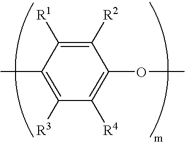
wherein R¹ and R³ are each independently selected from the group consisting of hydrogen, halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, C₆-C₁₂ aryl, C₁-C₁₂ haloalkyl, C₁-C₁₂ hydrocarbyloxy, and C₂-C₁₂ halohydrocarbyloxy wherein at least two carbon atoms separate the halogen and oxygen atoms; R² and R⁴ are each independently selected from the group consisting of halogen, primary or secondary C₁-C₁₂ alkyl, C₂-C₁₂ alkenyl, C₂-C₁₂ alkynyl, C₁-C₁₂ aminoalkyl, C₁-C₁₂ hydroxyalkyl, C₆-C₁₂ aryl, C₁-C₁₂ haloalkyl, C₁-C₁₂ hydrocarbyloxy, and C₂-C₁₂ halohydrocarbyloxy wherein at least two carbon atoms separate the halogen and oxygen atoms; m is 1 to about 200; and K is a capping group selected from the group consisting of 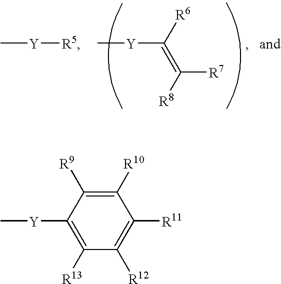
wherein R⁵ is C₁-C₁₂ alkyl; R⁶-R⁸ are each independently selected from the group consisting of hydrogen, C₁-C₁₈ hydrocarbyl, C₂-C₁₈ hydrocarbyloxycarbonyl, nitrile, formyl, carboxylate, imidate, and thiocarboxylate; R⁹-R¹³ are each independently selected from the group consisting of hydrogen, halogen, C₁-C₁₂ alkyl, hydroxy, and amino; and wherein Y is a divalent group selected from the group consisting of 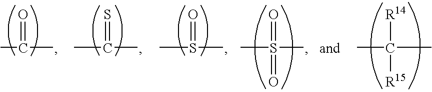
wherein R¹⁴ and R¹⁵ are each independently selected from the group consisting of hydrogen and C₁-C₁₂ alkyl.

12. The method of claim 11, wherein Q is the residuum of a monohydric phenol and y is 1.

13. The method of claim 11, wherein Q is the residuum of a dihydric phenol and y is 2.

14. The method of claim 11, wherein the capped poly(arylene ether) comprises at least one capping group having the structure 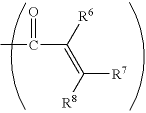
wherein R⁶-R⁸ are each independently selected from the group consisting of hydrogen, C₁-C₁₈ hydrocarbyl, C₂-C₁₂ hydrocarbyloxycarbonyl, nitrile, formyl, carboxylate, imidate, and thiocarboxylate.

15. The method of claim 14, wherein R⁶ is hydrogen or methyl, and R⁷ and R⁸ are hydrogen.

16. The method of claim 1, wherein the functionalized poly(arylene ether) is a ring-functionalized poly(arylene ether) comprising repeating structural units having the formula 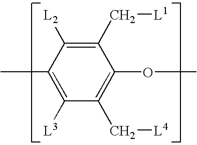
wherein each L¹-L⁴ is independently hydrogen, an alkenyl group, or an alkynyl group; wherein the alkenyl group is represented by 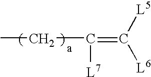
wherein L⁵-L⁷ are independently hydrogen or methyl, and a is an integer from 1 to 4; wherein the alkynyl group is represented by [symbol]
CH₂ [symbol] _{b}C≡C-L⁸
wherein L⁸ is hydrogen, methyl, or ethyl, and b is an integer from 1 to 4; and wherein about 0.02 mole percent to about 25 mole percent of the total L¹-L⁴ substituents in the ring-functionalized poly(arylene ether) are alkenyl and/or alkynyl groups.

17. The method of claim 1, wherein the curable poly(arylene ether) composition comprises about 1 to about 90 parts by weight of the functionalized poly(arylene ether) per 100 parts by weight total of the functionalized poly(arylene ether) and the acryloyl monomer.

18. The method of claim 1, wherein the olefinically unsaturated monomer is selected from acryloyl monomers, alkenyl aromatic monomers, allylic monomers, vinyl ethers, maleimides, and mixtures thereof.

19. The method of claim 1, wherein the olefinically unsaturated monomer comprises an acryloyl monomer comprising at least one acryloyl moiety having the structure 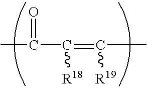
wherein R¹⁸ and R¹⁹ are each independently selected from the group consisting of hydrogen and C₁-C₁₂ alkyl, and wherein R¹⁸ and R¹⁹ may be disposed either cis or trans about the carbon-carbon double bond.

20. The method of claim 1, wherein the olefinically unsaturated monomer comprises an acryloyl monomer comprising at least one acryloyl moiety having the structure 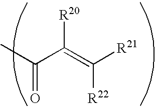
wherein R²⁰-R²² are each independently selected from the group consisting of hydrogen, C₁-C₁₂ hydrocarbyl, C₂-C₁₈ hydrocarbyloxycarbonyl, nitrile, formyl, carboxylate, imidate, and thiocarboxylate.

21. The method of claim 20, wherein the acryloyl monomer comprises at least two acryloyl moieties.

22. The method of claim 20, wherein the acryloyl monomer comprises at least three acryloyl moieties.

23. The method of claim 1, wherein the curable poly(arylene ether) composition comprises about 10 to about 99 parts of the olefinically unsaturated monomer per 100 parts by weight total of the functionalized poly(arylene ether) and the olefinically unsaturated monomer.

24. The method of claim 1, wherein the filler comprises a particulate filler, a fibrous filler, or a mixture thereof.

25. The method of claim 1, wherein the curable poly(arylene ether) composition further comprises a polyolefin powder having an average particle size less than 100 micrometers.

26. The method of claim 25, wherein the polyolefin powder is selected from high density polyethylene, low density polyethylene, polypropylene, poly(ethylene-co-vinyl acetate), halogenated polyolefins, and mixtures thereof.

27. The method of claim 1, wherein the curable poly(arylene ether) composition further comprises a hydroxy-containing polymer selected from polyalkylene glycols, hydroxy-containing hydrocarbon polymers, hydroxy-containing polyesters, and mixtures thereof.

28. The method of claim 1, wherein the curable poly(arylene ether) composition further comprises a polyisocyanate compound.

29. The method of claim 1, wherein the curable poly(arylene ether) composition further comprises a hydroxy-containing polymer and a polyisocyanate compound.

30. The method of claim 1, wherein the curable poly(arylene ether) composition further comprises a curing initiator.

31. The method of claim 1, wherein the curable poly(arylene ether) composition further comprises an additive selected from impact modifiers, dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, and combinations thereof.

32. A method of compression molding a curable composition, comprising:
introducing a curable poly(arylene ether) composition into a compression mold;
closing the mold a first time and applying to the curable poly(arylene ether) composition a first temperature of about 130 to about 170° C. and a first pressure of about 2,000 to about 20,000 kilopascals for about 5 to about 60 seconds;
opening the mold for about 0.01 to about 1 second; and
closing the mold a second time and applying to the curable poly(arylene ether) composition a second temperature of about 130 to about 170° C. and a second pressure about 2,000 to about 20,000 kilopascals for about 20 to about 100 seconds;
wherein the curable poly(arylene ether) composition comprises
a (meth)acrylate-capped poly(arylene ether) resin,
an acryloyl monomer comprising at least two acryloyl moieties, and
a filler.

33. A method of compression molding a curable composition, comprising:
introducing a curable poly(arylene ether) composition into a compression mold;
closing the mold a first time and applying to the curable poly(arylene ether) composition a first temperature of about 140 to about 160° C. and a first pressure of about 4,000 to about 10,000 kilopascals for about 10 to about 30 seconds;
opening the mold for about 0.01 to about 0.1 second; and
closing the mold a second time and applying to the curable poly(arylene ether) composition a second temperature of about 140 to about 160° C. and a second pressure of about 4,000 to about 10,000 kilopascals for about 20 to about 100 seconds;
wherein the curable poly(arylene ether) composition comprises
a functionalized poly(arylene ether) comprising a (meth)acrylate-monocapped poly(2,6-dimethyl-1,4-phenylene ether) resin or a (meth)acrylate-dicapped poly(2,6-dimethyl-1,4-phenylene ether) resin; wherein the functionalized poly(arylene ether) has an intrinsic viscosity of about 0.2 to about 0.3 deciliters per gram measured at 25° C. in chloroform,
an acryloyl monomer selected from trimethylolpropane tri(meth)acrylate, ethoxylated trimethylolpropane tri(meth)acrylate, neopentyl glycol di(meth)acrylate, dipropylene glycol di(meth)acrylate, ethoxylated bisphenol A di(meth)acrylate, ethylene glycol di(meth)acrylate, and mixtures thereof, and
a filler.

34. A molded article prepared according to the method of claim 1.

35. The molded article of claim 34, having an impulse breakdown voltage of at least 90 kilovolts.

36. A molded article prepared according to the method of claim 32.

37. A molded article prepared according to the method of claim 33.
